(19) United States
(12) Patent Application Publication
(10) Pub. No.: US 2024/0247390 A1
(43) Pub. Date: Jul. 25, 2024

(54) METHOD FOR OPERATING AN ELECTROLYZER AND A FUEL CELL BY MEANS OF A COMMON CONVERTER, APPARATUS AND ELECTROLYSIS SYSTEM

(71) Applicant: SMA Solar Technology AG, Niestetal (DE)

(72) Inventors: Alexander Unru, Baunatal (DE); Andreas Falk, Kassel (DE); Ralf Juchem, Felsberg (DE)

(21) Appl. No.: 18/627,548

(22) Filed: Apr. 5, 2024

Related U.S. Application Data
(63) Continuation of application No. PCT/EP2022/074490, filed on Sep. 2, 2022.

(30) Foreign Application Priority Data
Oct. 5, 2021 (DE) 10 2021 125 875.8

(51) Int. Cl. C25B 15/02; H01M 8/04082; H01M 8/04303; H01M 8/04858; H01M 8/0656; H02M 3/04; H02M 7/44

(52) U.S. Cl. CPC C25B 15/02; H01M 8/04201; H01M 8/04303; H01M 8/04917; H01M 8/0656; H02M 3/04; H02M 7/44

(57) ABSTRACT

The application describes a method for operating an electrolyzer and a fuel cell which, in parallel with one another, are connected to a device-side converter connection of a common bidirectional converter, on

### REFERENCE TO RELATED APPLICATIONS

This Application is a Continuation of International Application number PCT/EP2022/074490, filed on Sep. 2, 2022, which claims the benefit of German Application number 10 2021 125 875.8, filed on Oct. 5, 2021. The contents of the above-referenced Patent Applications are hereby incorporated by reference in their entirety.

### FIELD

The disclosure relates to a method for operating an electrolyzer and a fuel cell via a common converter. The disclosure furthermore relates to an apparatus configured to carry out the method, and to an electrolysis system having such an apparatus.

### BACKGROUND

It is known how to produce gaseous hydrogen from water by means of an electrolysis reaction. In order to operate the method at a high production rate, an electrolyzer in which the electrolysis reaction takes place can be connected via a rectifier to an energy supply network, for example an AC voltage network (AC network). The rectifier serves as an electrical supply unit of the electrolyzer, via which the production rate of hydrogen can also be controlled. Such electrolyzers can assume a nominal power up to a few 10 MW.

The hydrogen produced via electrolysis is used in different industry branches, for example steel processing, and comes into the processing processes in this field. In addition, the hydrogen can also be used as a medium for storing energy, in particular for seasonal energy storage. For example, the hydrogen can be supplied to a fuel cell for generating energy if necessary, and can ensure or support a safe electrical supply of local consumers in addition to local energy generating systems and/or battery accumulators. In this way, a long-term lasting high energy consumption of a large consumption unit, for example an industrial drive, can also be operated at the higher-level power supply network, such that energy relating to the energy supply network remains as far as possible within tolerance limits which have previously been agreed with an operator of the energy supply network. In addition to the function as a local energy source, the fuel cell additionally makes it possible to provide an increased level of network services if required when combined with a power converter connected to it, For example, positive control power (i.e. active power that can be fed into the energy supply network) can be kept available and made available to the energy supply network even over a longer period of time during retrieval.

Industrial works that require hydrogen within their production processes are currently increasingly generating the required hydrogen as close as possible to production themselves by means of electrolysis. For the aforementioned reasons, it is currently increasingly required to operate an electrolyzer and a fuel cell on a common power distribution network. Depending on the application, it can be a DC voltage network (DC network) or an AC voltage network (AC network).

In order to operate a fuel cell and an electrolyzer, which are connected to a common power distribution network, as independently as possible, it is known how to connect both units to the power distribution network via a separate converter. Thus, the document CN 212726480 U discloses a fuel cell and an electrolyzer which are connected to a common DC power bus via a separate DC/DC converter in each case. Although it is sufficient to design the separate converters as unidirectional converters, such a system is nevertheless often associated with high costs especially at the intended services.

From the document WO 2021 100112 A1, a fuel cell and an electrolyzer are known to operate on a common DC power bus. The DC power bus is connected to an AC voltage network via a DC/AC converter. Both electrolyzer and fuel cell have power voltage characteristic curves which characterize their electrical power to be absorbed or output by the DC power bus to the DC power bus. Here, electrolyzer and fuel cell have a common voltage range. A change in a DC voltage of the DC power bus results in a change in the power related to the electrolyzer from the DC power bus, as well as a change in the power output by the fuel cell to the DC power bus.

However, it is generally desired for the application to decouple both units at least In such a way that either the fuel cell, but not the electrolyzer, or the electrolyzer, but not the fuel cell, can be operated. This is the case in particular for a combination of electrolyzer and a fuel cell in which a chemical substance generated by the electrolyzer by means of energy burning electrolysis, for example hydrogen, is again utilized by the fuel cell for generating energy and feeding into a common network.

Document U.S. Pat. No. 4,341,607 A discloses a solar energy system comprising a photovoltaic generator having a series of peak power points for different solar radiation levels, a voltage-dependent load with variable resistance, such as a water electrolysis unit, which is electrically connected to the photovoltaic generator, and a demand-dependent load with variable resistance, such as an inverter, which is connected in parallel to the electrolysis unit. The voltage-dependent load has a voltage-current characteristic in which the working point for most solar radiation values is shifted from the peak power point of the photovoltaic generator toward higher voltage and lower current operating points. The inverter can shift the operating point of the photovoltaic generator in the direction of its peak power point when the load requires power. A fuel cell can be connected in parallel with the photovoltaic generator in order to supply power to the inverter at times of low solar radiation. The fuel cell can use the hydrogen generated by the electrolysis unit as a fuel. The entire photovoltaic power provided by the solar power system is generally greater than 95 percent of the maximum power that the photovoltaic generator can generate for many solar radiation values.

### SUMMARY

The disclosure is directed to a method for operating an electrolyzer and a fuel cell which are connected to an energy supply network or power distribution network via a common converter. The method enables separate operation of the electrolyzer and the fuel cell during which each device can be set independently of the respective other in its power draw from the network or in its power feed into the network. The mutually independent adjustability of both devices from electrolyzer and fuel cell takes place as far as possible over an entire operating region of the corresponding device. The method should be implementable as inexpensively as possible. The disclosure is also directed to an apparatus suitable for carrying out the method and an electrolysis system configured to carry out the method.

The method according to the disclosure aims to operate an electrolyzer as a load and a fuel cell as an energy generator which are connected in parallel with one another with a device-side converter connection of a common bidirectional converter. The network-side converter connection of the common converter is connected to a network. The electrolyzer comprises an open-circuit voltage U_{0,EL} that characterizes an electrolysis reaction that starts in the electrolyzer. The fuel cell comprises an open-circuit voltage U_{0,FC} that characterizes a terminal voltage in the currentless state of the fuel cell. The electrolyzer and the fuel cell are designed such that the open-circuit voltage of the electrolyzer U_{0,EL} is greater than or equal to the open-circuit voltage of the fuel cell U_{0,FC}; in other words, U_{0,EL}>U_{0,FC} applies. The method comprises:

a. operating the common bidirectional converter with a DC voltage U_{DC} applied to its device-side converter connection that is higher than the open-circuit voltage of the electrolyzer, i.e. U_{DC}>U_{0,EL} to control an electrolysis reaction running in the electrolyzer, wherein a power is taken from the network and supplied to the electrolyzer by means of the converter, and a current or power flow into the fuel cell is suppressed by a first reverse current protection means, and
b. operating the common bidirectional converter if necessary with a DC voltage U_{DC} applied to its device-side converter connection below the open-circuit voltage of the fuel cell U_{0,FC}, i.e with U_{DC}<U_{0,FC}, wherein a power of the fuel cell is taken from the fuel cell and supplied to the network.

A network in the sense of one embodiment of the present application is to be understood as a power bus shared by the electrolyzer and the fuel cell. The network can be an energy distribution network of a building, for example, an energy distribution network of an industrial operation. However, it is also possible for the network to be a higher-level power supply network to which different buildings with their corresponding power distribution networks are connected. In one embodiment, the network can be designed as an AC voltage network (AC network) or as a DC voltage network (DC network). The electrolyzer can, for example, be an electrolyzer which generates a chemical substance by means of an electrolysis reaction, which can be used again as an energy source by the fuel cell during its operation. In other words, in one embodiment, within the scope of the disclosure, a combination of electrolyzer and fuel cell is as far as possible such that a starting product for the energy-generating operation of the fuel cell corresponds to an end product of the electrolysis reaction running in the electrolyzer under energy consumption. Specifically, in one embodiment, the electrolyzer can be an electrolyzer in which water is decomposed into hydrogen and oxygen by means of an electrolysis reaction. The fuel cell can, in one embodiment, be a fuel cell in which hydrogen and oxygen react to form water while producing power. A need case in which the bidirectional converter generates a DC voltage at its device-side converter connection, which voltage is below the open-circuit voltage of the fuel cell, can be of different types. For example, the need case may arise in that a power balance between power generation and energy consumption within the network has an increased energy consumption which is to be counteracted by means of a support of the network by feeding active power into the network. It can also be, in one embodiment, that the power balance within the network has an energy generation increased relative to the energy consumption, wherein the network is then to be supported by an increased energy consumption. Such a network support can thereby be triggered and controlled such that a network parameter, for example, a frequency of an AC voltage in a network designed as an AC network, or a magnitude of a DC voltage in a network designed as a DC network, falls below a previously specified threshold value. However, it is also possible, in one embodiment, for an operator of the network to prompt or request network support by feeding in active power in another manner, for example via a signal transmitted via radio or cable.

The disclosure uses the effect that an operation of the electrolyzer and an operation of the fuel cell over a value of the respectively associated open-circuit voltages U_{0,EL}, U_{0,FC} are separated or decoupled from one another. A working region of the electrolyzer in which an electrolysis reaction takes place thus begins at DC voltages above its open-circuit voltage U_{0,EL}. The speed of the electrolysis reaction, in other words the hydrogen generation rate, increases with increasing DC voltage. Below the open-circuit voltage of the electrolyzer U_{0,EL} no, or at least no appreciable electrolysis reaction takes place. Rather, the electrolyzer has a predominantly capacitive behavior in this range, which is characterized by the formation of double layers within the electrolytic cells. The fuel cell, on the other hand, has a working region which, toward the top, is limited by its open-circuit voltage U_{0,FC}. Here, the open-circuit voltage U_{0,FC} characterizes a currentless state of the fuel cell. When the current is increasingly taken from the fuel cell, or also in case of removed electrical power, the voltage decreases at a connection associated with the fuel cell due to its internal resistance. The behavior is similar to that of a battery, the terminal voltage of which also decreases as the current taken from the battery increases.

With the open-circuit voltage of the electrolyzer U_{0,EL} being greater than or equal to the open-circuit voltage of the fuel cell U_{0,FC}, a selective operation of the electrolyzer in an upper voltage band of the DC voltage U_{DC} results. In this case, a power flow into the fuel cell, and an electrolysis reaction, possibly triggered thereby, within the fuel cell—possibly also any damage thereof—is prevented by the first reverse current protection means. The first reverse current protection means is therefore designed such that an active power flow from the device-side converter connection into the fuel cell is suppressed, but is made possible from the fuel cell into the device-side converter connection. The electrolyzer, in one embodiment, thus operates in the upper voltage band, but not at the same time as the fuel cell. A change in the DC voltage applied to the device-side converter connection thus has an influence on an electrolysis reaction running in the electrolyzer, but does not cause any change in the operation of the fuel cell. In contrast, in a lower voltage band, which is limited toward the top by the open-circuit voltage U_{0,FC} of the fuel cell, the fuel cell operates selectively, while the electrolysis reaction within the electrolyzer due to the magnitude of the DC voltage applied to its connections, which is below the open-circuit voltage of the electrolyzer U_{0,EL} is effectively suppressed. In summary, two voltage bands result which characterize the working regions of electrolyzer and fuel cell, namely an upper voltage band for the working region of the electrolyzer and a lower voltage band for the working region of the fuel cell. In one embodiment, the two voltage bands can, at most, adjoin one another, which is the case when both open-circuit voltages are equal i.e U_{0,FC}=U_{0,EL}, but they do not overlap. However, it is also possible in another embodiment that the voltage bands do not adjoin one another, but rather are separated from one another by a voltage range ΔU different from 0 V, ΔU≠0. By means of the voltage bands arranged relative to one another in this way, the electrolyzer and the fuel cell can be operated selectively with respect to one another via a common converter. A change in the DC voltage applied to the device-side converter connection within a voltage band thus only results in a change in the operation of the device associated with the respective voltage band, but not of the device that is associated with the respective other voltage band. Specifically, the electrolyzer can be set in its energy consumption without causing a change in an active power flow taken from the fuel cell.

In one embodiment, the electrolyzer comprises a series connection of a plurality of electrolysis cells, which are often also structurally identical to one another. The outwardly effective open-circuit voltage of the electrolyzer U_{0,EL} therefore results from the sum of the open-circuit voltages of all of its electrolysis cells, i.e. within the series circuit. The same applies to the fuel cell which contains a series connection of individual fuel cells. Here, too, the open-circuit voltage of the fuel cell U_{0,FC} that is effective toward the outside results from a sum of the open-circuit voltages associated with the fuel cells. Both for the electrolyzer and for the fuel cell, the outwardly effective open-circuit voltages U_{0,EL}, U_{0,FC} may be modified in a simple manner via a change in the number of electrolysis cells within the series connection of the electrolyzer, or via a change in the number of individual fuel cells within the series connection of the fuel cell, and are adapted relative to one another. In this way, the combination of electrolyzer and fuel cell, which are connected to the common converter, can always be designed in their open-circuit voltages in such a way that two voltage bands which are spaced apart from one another result, or two voltage bands directly adjacent to one another. By using a common converter for the two devices, the method is significantly more cost-effective than a conventional method in which a separate converter is to be kept for each device. Despite the common converter, a sufficient decoupling of both devices during operation is ensured via the first reverse current protection means.

An apparatus according to the disclosure for operating an electrolyzer and a fuel cell by means of a common converter comprises:
a network-side apparatus connection for connecting a network, a first device-side apparatus connection for connecting the fuel cell and a second device-side apparatus connection for connection of the electrolyzer.
a bidirectionally designed converter as the common converter, which is connected to the network-side apparatus connection with its network-side converter connection, and which, on the one hand, is connected to the first device-side apparatus connection via a first reverse-current protection means and the device-side converter connection is connected to the second device-side apparatus connection, and the converter connection on the other hand, and
a control circuit for controlling the apparatus, in particular the bidirectional converter. The apparatus is set up in a state connected to the electrolyzer, the fuel cell, and the network for carrying out the method according to the disclosure.

By virtue of the device-side converter connection being connected on the one hand to the first apparatus connection and on the other hand to the second apparatus connection, the first apparatus connection and the second apparatus connection are also connected in parallel with one another with the device-side converter connection. In this case, the link of the device-side converter connection to the second apparatus connection can be present in a direct manner, in particular without interposition of a return current means. The features and advantages already explained in relation to the method result.

An electrolysis system according to the disclosure for operation on a network and for the support thereof comprises an electrolysis unit with an electrolyzer, a fuel cell unit having a fuel cell, and an apparatus according to the disclosure. The fuel cell is connected to the first device-side apparatus connection and the electrolyzer is connected to the second device-side apparatus connection. The electrolysis system is set up in a state connected to the network for carrying out the method according to the disclosure. The features and advantages already listed in connection with the method result here as well.

Advantageous embodiments of the disclosure are specified in the following description and the dependent claims, the features of which can be applied individually and in any desired combination with one another.

If the device-side converter connection is directly connected to the second apparatus connection, i.e., without an interposed reverse current protection means, a charge stored in an input capacitance of the electrolyzer can be used in addition to the current taken from the fuel cell for a power flow driven by the bidirectional converter into the network. Starting from the open-circuit voltage of the electrolyzer U_{0,EL}, typically initially a power flow is taken from the input capacitance of the electrolyzer with decreasing DC voltage at the device-side converter connection. If the DC voltage at the device-side converter connection is also to the open-circuit voltage of the fuel cell U_{0,FC} in addition to the current from the input capacitance of the electrolyzer, a current (and thus a power) which is (are) taken from the fuel cell also result(s). The power fed into the network can thus at least temporarily exceed a power that corresponds to a maximum power that can be withdrawn from the fuel cell, provided that a maximum permitted power of the converter is not exceeded. However, the capacity of the electrolyzer is thereby at least partially discharged. It must therefore be supplied again to the input capacity of the electrolyzer via the converter when the electrolyzer is to operate again in its electrolysis mode. This can be desired in certain applications, however, in others in which a change as fast as possible between a surgical operation of the fuel cell and the electrolyzer is required it may be rather undesirable. In an alternative variant of the method, on the other hand, when operating the converter, a DC voltage U_{DC} applied to its device-side converter connection a current below the open-circuit voltage of the fuel cell U_{0,FC}, in particular a power flow from the electrolyzer in the direction of the converter, can therefore be suppressed via a second reverse current protection means.

In one embodiment of the method, the network can be an AC voltage network (AC network). In this case, the bidirectional converter can comprise a bidirectional DC/AC converter. The AC network can be designed as a single-phase AC network with a phase conductor and a neutral conductor, wherein the DC/AC converter is then also designed as a single-phase converter. Within the scope of the disclosure, however, it is also possible for the AC network, as well as the bidirectional DC/AC converter, to be designed in a multi-phase, in particular three-phase manner. The multi-phase AC network can, but does not necessarily have to have a neutral conductor. Correspondingly, the network-side converter connection can optionally also comprise a neutral conductor connection. The bidirectional converter of the apparatus can be designed in multiple stages and, in addition to a bidirectional DC/AC converter, contain a bidirectional DC/DC converter which is downstream of the DC/AC converter in the direction of the first apparatus connection and also of the second apparatus connection. In particular, the DC/DC converter is connected to the bidirectional DC/AC converter with one of its connections and to the device-side converter connection with its other connection. In the context of the disclosure, however, in a network designed as an AC network, it is also possible for the bidirectional converter of the apparatus to be designed in one stage and in particular to be free of a bidirectional DC/DC converter. In a DC/AC converter with a two-level topology, the DC voltage U_{DC} applied to the device-side converter connection can be greater than or equal to the amplitude of the AC voltage prevailing at the network-side apparatus connection. In a DC/AC converter having a three-level topology, the DC voltage applied to the device-side converter connection can be greater than or equal to twice the amplitude of the AC voltage applied to the apparatus connection.

In a further embodiment of the method, the network may be designed as a DC network. In this case, the bidirectional converter can also comprise a bidirectional DC/DC converter or be designed as such.

As described above, it is in principle possible for the voltage bands of electrolyzer and fuel cell to directly adjoin one another, i.e U_{0,FC}=U_{0,EL} applies. However, due to component tolerances or temperature influences that are not completely to be avoided, the individual open-circuit voltages associated with the electrolysis cells within their series connection and/or the individual open-circuit voltages associated with the fuel individual cells within their series circuit can each easily differ from one another. In the case of directly adjacent voltage bands of electrolyzer and fuel cell, it can therefore be that even in the case of a DC voltage applied to the connections of the electrolyzer at the level of its nominally specified open-circuit voltage U_{0,EL}, some of its electrolysis cells are slightly above their associated open-circuit voltage at the expense of the other electrolytic cells within the series circuit. In other words, due to component tolerances and/or temperature influences, an electrolysis reaction can already take place in some of the electrolysis cells, although this is not yet intended due to the applied DC voltage at the level of the open-circuit voltage of the electrolyzer. In one embodiment of the method, electrolyzer and fuel cell are matched to one another in terms of their structure such that the open-circuit voltage of the electrolyzer U_{0,EL} by at least 0.1 V, preferably by at least 1 V and particularly preferably by at least 10 V above the open-circuit voltage of the fuel cell U_{0,FC}. If necessary, for example when using cost-effective voltage sensors with only low accuracy, the open-circuit voltage U_{0,EL} of the electrolyzer may also be further above the U_{0,FC} of the fuel cell. In these cases, the voltage bands of electrolyzer and fuel cell are spaced apart from one another via a voltage range different from 0 V, or—which is tantamount—are separated from one another. Via the distance of both open-circuit voltages from one another, an electrolysis reaction which is unintentionally running in individual electrolysis cells can be suppressed, or at least reduced.

In one embodiment of the method, the fuel cell can be supplied with a fuel gas which has previously been locally generated and optionally temporarily stored by means of the electrolyzer. For this purpose, the electrolysis system can additionally have a storage tank for storing the electrolysis product produced by the electrolyzer. The storage tank can be connected to the fuel cell to supply the fuel gas to the fuel cell. The supply can be controlled by a control circuit of the electrolysis system. This simplifies the entire operation of the electrolysis system, since it eliminates the effort for the procurement of a fuel gas that is only required for operating the fuel cell but otherwise not required. Rather, when the electrolysis system operates in an operating mode with an electrolysis reaction running in the electrolyzer, it can first be ensured that the storage tank is sufficiently filled with the electrolysis product. Only when a provided minimum fill level of the storage tank is reached or exceeded can the resulting electrolysis product be utilized for its otherwise intended purpose, for example utilization in steel production. In this way, it can be ensured that operation of the fuel cell is always guaranteed and, if required, can also take place for a short time, at least for a predefined period of time. The electrolyzer can in particular be an electrolyzer which is designed to generate hydrogen from water via an electrolysis reaction. Correspondingly, the fuel cell can be designed as a fuel cell operating with hydrogen as fuel gas.

In one embodiment of the method, the DC voltage U_{DC} applied to the device-side converter connection can be provided depending on a network parameter. If the network is designed as an AC network, the network parameter can in particular be a frequency of an AC voltage of the AC network. Specifically, the DC voltage can, for example, increase at the device-side converter connection with increasing frequency of the AC voltage in the AC network. As a result, when the DC voltage is above the open-circuit voltage of the electrolyzer, i.e. an electrolysis reaction in the electrolyzer takes place, an active power flow from the network into the electrolyzer increases with increasing frequency. If, on the other hand, the DC voltage is below the open-circuit voltage of the fuel cell, an increasing DC voltage leads to a decrease in an active power flow taken from the fuel cell and fed into the AC network at the device-side converter connection. In both cases, this results in a network-supporting operation of the apparatus in which an increase in frequency is counteracted by a reduction of active power fed into the AC network or by an increase of active power taken from the AC network. In this case, an active power to be removed or fed to the AC network at a certain frequency can be stored in the form of a characteristic curve stored in the converter, here, for example, an active power-frequency characteristic curve. A controller of the converter can then control the semiconductor switches of the converter in accordance with the stored characteristic curve in such a way that at each frequency within the AC network, the active power corresponding to the active power-frequency characteristic curve is exchanged with the AC network.

If, on the other hand, the network is designed as a DC network, the network parameter can correspond to a magnitude of a DC voltage of the DC network. Specifically, the DC voltage set at the device-side converter connection can increase with increasing magnitude of the DC voltage prevailing in the DC network. Here, too, in the case of a DC voltage at the device-side converter connection above the open-circuit voltage of the electrolyzer with increasing DC voltage in the DC network, an increase in the active power drawn from the network and flowing into the electrolyzer results. In the case of a DC voltage applied to the device-side converter connection, below the open-circuit voltage of the fuel cell, a reduction of an active power drawn from the fuel cell and fed into the network results from an increase in the DC voltage prevailing in the DC network. Even in the case of a DC network, a characteristic curve, here in particular an active power-voltage characteristic curve, can be stored in the converter, which characteristic curve indicates which voltage within the DC network is to cause the active power exchange. A control circuit of the converter can then control semiconductor switches of the converter such that the active power exchanged with the DC network always corresponds to the value indicated in the characteristic curve. In summary, a network-supporting operation of the apparatus or of the electrolysis plant can thus also be realized in the DC network, which counteracts an increase in the DC voltage prevailing in the DC network by reducing active power that is fed into the network or an increase in active power taken from the network.

The first reverse current protection means of the apparatus can comprise a switch or a diode. The switch can be an electromechanical switch or an actively controlled semiconductor switch. In the context of the disclosure, a parallel circuit of an electromechanical switch and a semiconductor switch or a parallel circuit of an electromechanical switch and a diode is also possible. In the case of the parallel circuits which have an electromechanical switch, the electromechanical switch can be closed in case of a DC voltage at the device-side converter connection which drops in time if the DC voltage reaches or falls below a threshold value below the open-circuit voltage of the fuel cell U_{0,FC}. A power loss converted in the diode can thereby be reduced. On the other hand, the electromechanical switch can be opened when the DC voltage applied to the converter connection is increased over time if the DC voltage reaches or exceeds the threshold value. The threshold value can, for example, be between 0.7 V and 5 V below the open-circuit voltage of the fuel cell.

Although it is possible for the device-side converter connection to be connected directly, in particular without interposition of a reverse current protection means, to the second device-side apparatus connection, in an alternative embodiment of the apparatus, the device-side converter connection can be connected to the device-side apparatus connection via a second reverse current protection means. Specifically, the second reverse current protection means can be arranged in a link line between the second device-side apparatus connection and an electrical link from the device-side converter connection to the first reverse current protection means. The second reverse current protection means can comprise a diode or a switch, just like the first reverse current protection means. The switch can be designed as an electromechanical switch or as an actively controlled semiconductor switch. Within the scope of the disclosure, a parallel circuit of an actively controlled semiconductor switch and an electromechanical switch, or a parallel circuit of a diode and an electromechanical switch, is also possible for the second reverse current protection means. The electromechanical switch can then be closed when the DC voltage applied to the device-side converter connection increases within the voltage band associated with the electrolyzer, and in particular a further threshold value above the open-circuit voltage of the electrolyzer U_{0,EL} is reached or exceeded. Similarly to the first reverse current protection means, a power loss in the diode or the closed semiconductor switch can thus be reduced. Correspondingly, the electromechanical switch can be opened at a DC voltage applied to the device-side converter connection, which drops over time within the voltage band associated with the electrolyzer, when the further threshold value is reached or undershot. Advantageously, the further threshold value can be in a range between 0.7 V and 5 V above the open-circuit voltage of the electrolyzer U_{0,EL}. The second reverse flow protection means serves to prevent a power flow from the electrolyzer in the direction of the device-side converter connection when the DC voltage applied there falls below the open-circuit voltage of the electrolyzer U_{0,EL}. In this way, a discharge of the input capacitance of the electrolyzer can be at least largely suppressed. Any of the reverse-flow stabilizers, optionally also the combination of the first reverse current protection agent and the second reverse current protection agent is usually much less expensive to realize than to keep a separate converter available for each device of electrolyzer and fuel cell.

### BRIEF DESCRIPTION OF THE FIGURES

The disclosure is illustrated below with the aid of figures. In the figures:

FIG. 1 shows an embodiment of an electrolysis system according to the disclosure for operation on an AC network;

FIG. 2 shows a further embodiment of an electrolysis system according to the disclosure for operation on a DC network;

FIG. 3a shows a first embodiment of parts of the apparatus according to the disclosure;

FIG. 3b shows a second embodiment of parts of the apparatus according to the disclosure;

FIG. 3c shows a third embodiment of parts of the apparatus according to the disclosure;

FIG. 4 shows a schematic characteristic curve of an electrolyzer and a fuel cell according to one embodiment; and

FIG. 5 shows a flow chart of the method according to the disclosure for operating an electrolyzer and a fuel cell.

### DETAILED DESCRIPTION

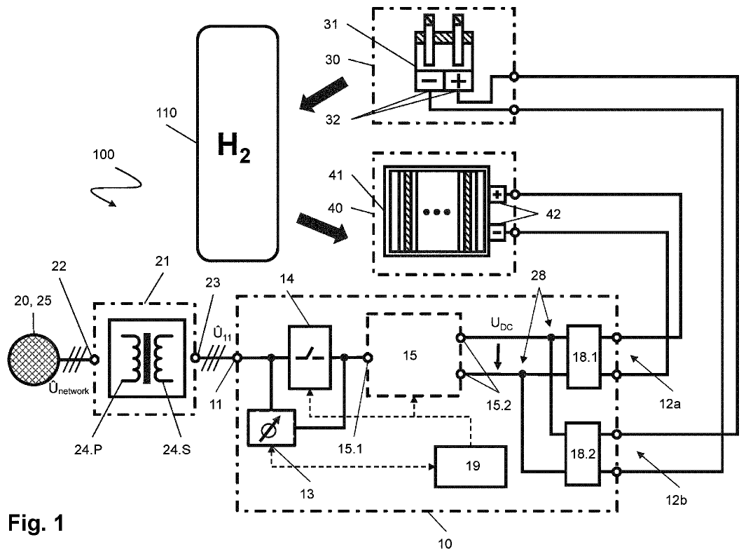

FIG. 1 shows an embodiment of an electrolysis system 100 according to the disclosure, which is connected to a network 20 for operation and is also designed to support the network 20 during its operation. The electrolysis system 100 comprises an electrolysis unit 30 with an electrolyzer 31, a fuel cell unit 40 with a fuel cell 41, and an apparatus 10 according to the disclosure for operating the electrolyzer 31 and the fuel cell 41.

The apparatus 10 is connected to the network 20 at its network connection 11. In the embodiment shown, the network 20 is configured as an AC voltage network (AC network) 25. A device-side apparatus connection 12b is connected to the connection 32 of the electrolysis unit 30, and/or of the electrolyzer 31 via a direct current (DC) bus. The DC bus is configured to supply DC electric power to the electrolyzer 31, by means of which electrolysis, for example, the decomposition of water into hydrogen and oxygen, is carried out in the electrolyzer 31. A further device-side connection 12a on the apparatus is connected to the connection 42 of the fuel cell unit 40 and/or the fuel cell 41 via a further DC bus. The further DC bus is configured to supply electrical DC power, which is generated in the fuel cell 41, for example, via the reaction of hydrogen and oxygen to water, to the apparatus 10.

The apparatus 10 comprises a bidirectional converter 15, which in this embodiment is realized as an AC/DC converter and is configured to convert an AC voltage applied to a network-side converter connection 15.1 with the amplitude Û₁₁ to a DC voltage U_{DC} applied to a device-side converter connection 15.2 or convert a DC voltage U_{DC} applied to the device-side converter connection 15.2 into an AC voltage applied to the network-side converter connection 15.1 with the amplitude Û₁₁, depending on the direction in which the bidirectional converter 15 is operated in relation to its power flow. For this purpose, semiconductor switches (not shown) of the AC/DC converter 15 are suitably controlled by a control circuit 19. The common bidirectional converter 15 is, with its device-side DC converter connection 15.2 via link points 28, connected to the first device-side apparatus connection 12a via a first reverse current protection circuit or means 18.1 on the one hand, and connected to the second device-side apparatus connection 12b via a second reverse-current protection circuit or means 18.2 on the other hand. A network-side converter connection 15.1 of the common bidirectional converter 15 is connected to the network-side apparatus connection 11 via a network isolating switch 14, here an AC isolation circuit or unit. This link circuit additionally comprises a measuring circuit or unit with a voltage sensor 13 configured to detect a voltage applied to the network connections 11, 15.1 in each case. The measuring circuit or unit can also comprise further detectors for further network parameters, such as, for example, current measurement or frequency measurement. All parameters detected by the measuring circuit or unit can be detected by the control circuit 19 and utilized for the adapted control. The control circuit 19 is furthermore able to control the AC isolation circuitry 14 and possibly also further components of the apparatus 10 or the electrolysis system 100. A first reverse current protection circuit or means 18.1 is arranged between the device-side converter connection 15.2 and the first device-side apparatus connection 12a, which is connected to the connection 42 of the fuel cell unit 40. The first reverse current protection circuit or means 18.1 is set up in such a way that a current flow or a power flow into the fuel cell 41 is suppressed, but a power flow from the fuel cell 41 in the direction of the common converter 15 is enabled. Furthermore, a second reverse current protection circuit or means 18.2 is arranged in the link path from the device-side common converter connection 15.2 of the common bidirectional converter 15 to the second device-side apparatus connection 12b, which is linked to the connection of the electrolysis unit 30. The second reverse current protection circuit or means 18.2 is configured in such a way that a current flow, for example, a power flow from the electrolyzer 31 in the direction of the converter 15 is suppressed, for example, when the fuel cell 41 is operated. In contrast to this, however, the second reverse current protection circuit or means is set up to enable a power flow from the common converter 15 into the electrolyzer 31. However, application examples are also conceivable in which no second reverse current protection circuit or means 18.2 is provided. It can thus be advantageous to provide a power flow from an input capacitance of the electrolyzer 31 to the converter 15 in addition to the power flow of the fuel cell 41 for network feed-in. The reverse current protection circuit or means 18.1, 18.2 can thereby be formed by various known active or passive circuits or circuit components or other means. The reverse current protection circuit or means can, for example, be provided by passive switches such as diodes or else by directly controllable switches. The embodiment as a switch can be an electromechanical switch or an actively controlled semiconductor switch. The reverse current protection circuits or means 18.1 and 18.2 can also be designed differently from one another. A suitable control of the switches is, in one embodiment, provided by the control circuit 19.

In FIG. 1, the apparatus 10 is connected to the network 20 designed as an AC network 25 via a transformer 21 by way of example. In this case, the network-side apparatus connection 11 is connected to a device-side connection 23 of the transformer 21 which is arranged on a secondary side 24S of the transformer 21. The network-side connection 22 of the transformer 21, which is arranged on a primary side 24P of the transformer 21, is connected to the AC network 25. However, the transformer 21 does not necessarily have to be present, which is symbolized by its dashed representation. If no transformer is present in other embodiments, the network-side apparatus connection 11 is directly connected to the AC network 25. The transformer 21, as well as the bidirectional converter 15, are shown as three-phase each in FIG. 1 by way of example. Alternatively, however, it is also possible in other embodiments that the AC network 25, the transformer 21, and the bidirectional converter 15 are configured as single-phase components and each have a phase conductor and a neutral conductor or neutral conductor connection. It is likewise possible for it to have a different number of phase conductors, for example, two phase conductors. The multi-phase AC network 25 does not necessarily have to have a neutral conductor.

In the embodiment of the electrolysis system 100 shown in FIG. 1, a storage tank 110 for storing the electrolysis product produced by the electrolyzer 31 (here: H₂) is provided. The storage tank 110 for supplying the fuel gas (here also H₂ by way of example) to the fuel cell 41 is connected to the fuel cell 41. The supply is, in one embodiment, controlled by the control circuit 19 of the electrolysis system 100. In this embodiment, hydrogen H₂ is provided as an electrolysis product of the electrolyzer 31 and as a fuel gas for the fuel cell 41. In this way, the fuel gas of the fuel cell 41 can be provided directly by the electrolysis plant 100, with the advantage that it does not have to be procured and kept available. For this purpose, it is advantageous that the storage tank 110 always has a minimum storage level, so that an operating mode with fuel cell operation can always be ensured. The additional hydrogen stored in the storage tank 110 can then be provided for its intended use, for example, utilization in steel production or as fuel. The storage tank 110 shown in FIG. 1, which is connected to the fuel cell 41 both for receiving an electrolysis product (here: H₂ by way of example) and for outputting a fuel gas (here also H₂ by way of example), is an optional component and not absolutely necessary. It is advantageous if at least one of the products formed in the electrolysis reaction is also used as a reactant within the fuel cell 41. If this is not the case, the storage tank 110 may be omitted. In the absence of storage tank 110, the electrolysis products—hydrogen H₂ in the case of water electrolysis and oxygen O₂—can thus be utilized directly for their proper purpose. Even in the case of the fuel cell 41, the reactants can thus—in the case of a fuel cell using methane as a fuel gas, this would be methane CH₄ among others—be supplied from the outside via pipelines.

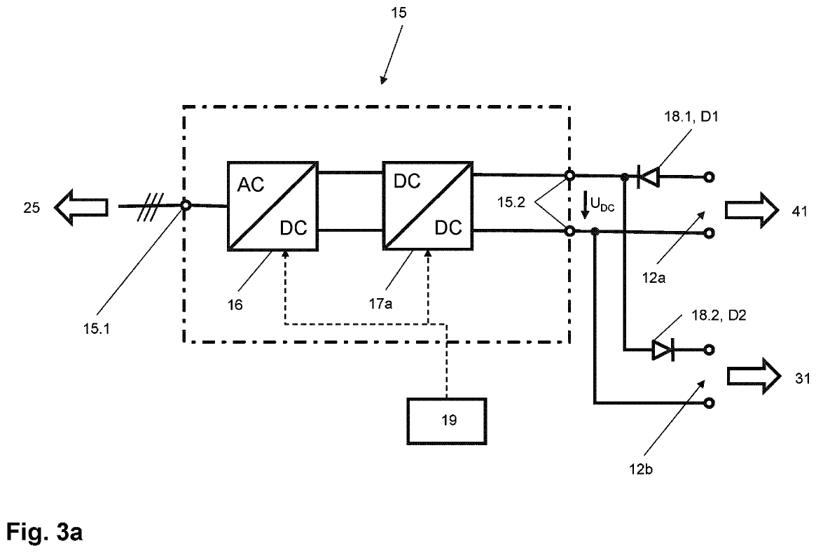

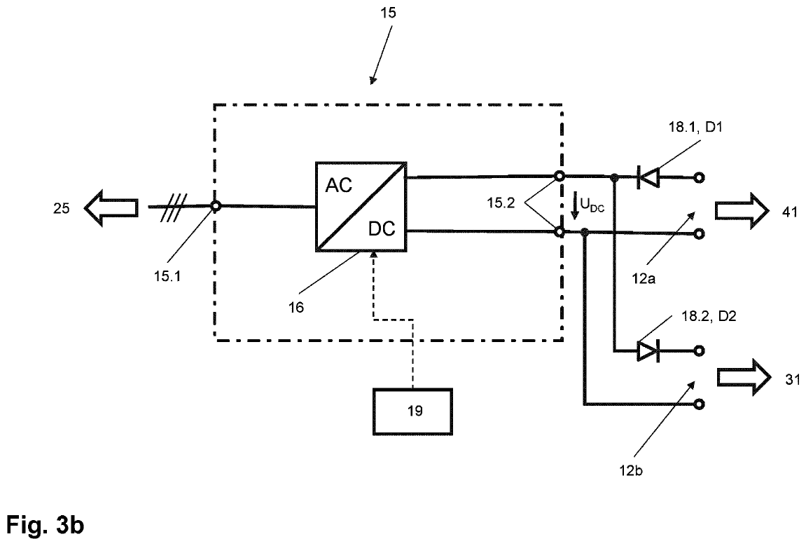

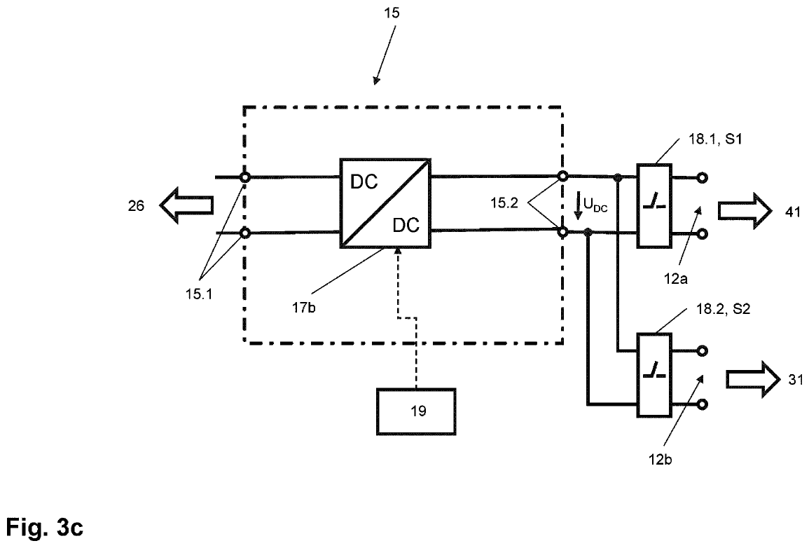

With the apparatus 10 according to the disclosure, which in parts (bidirectional converter 15 and reverse current protection means 18.1, 18.2) will be explained in more detail in FIGS. 3a, 3b, 3c, the electrolysis system 100 is designed and configured to control an operation of the electrolysis unit 30 and the fuel cell unit 40 according to the method according to the disclosure. The electrolysis unit 30 can be operated in a normal operating mode at an applied input voltage U_{DC} higher than its open-circuit voltage U_{0,EL}. In this operating mode, an electrolysis reaction takes place in the electrolyzer 31, for example, a decomposition of water into its components hydrogen and oxygen, wherein the electrolyzer 31 basically behaves like an ohmic consumer. A speed of the electrolysis reaction is thereby determined by means of the apparatus 10 via a variation of the input voltage U_{DC} of the electrolyzer 31. The electrolyzer can additionally be operated in a standby operating mode in which no electrolysis reaction, or at least no significant electrolysis reaction, and thus also no, or at least no significant electrical power consumption of the electrolyzer 31 takes place.

In one embodiment, the electrolyzer 31 contains a series connection of several electrolysis cells. The outwardly effective open-circuit voltage U_{0,EL} of the electrolyzer 31 results from the sum of the open-circuit voltages of all of its electrolysis cells. In the same manner, it applies to the fuel cell 41 that it may, in one embodiment, comprise a series circuit of individual fuel cells. Accordingly, the open-circuit voltage U_{0,FC} results from the sum of the open-circuit voltages associated with the individual fuel cells. The open-circuit voltages are selected and adapted such that two spaced-apart or at least adjacent voltage bands result for the operation of the fuel cell 41 and the electrolyzer 31. Thus, U_{0,EL}≥U_{0,FC.}applies. The operating modes of the electrolysis plant with electrolysis operation and fuel cell operation are therefore decoupled from one another and separated. If the common bidirectional converter 15 is connected to a DC voltage U_{DC} applied to its device-side converter connection 15.2 that is higher than the open-circuit voltage U_{0,EL} of the electrolyzer 31, i.e U_{DC}>U_{0,EL}, the electrolysis plant 100 is in electrolysis operating mode. In order to control an electrolysis reaction taking place in the electrolyzer 31, a power is taken from the network 20 and supplied to the electrolyzer 31 by means of the converter 15 when the network isolating switch 14 is closed. A current or a power flow into the fuel cell 41 is suppressed by the first reverse current protection circuit or means 18.1.

If the common bidirectional converter 15 is operated with a DC voltage U_{DC} applied to its device-side converter connection 15.2 that is lower than the open-circuit voltage U_{0,FC} of the fuel cell 41, i.e U_{DC}<U_{0,FC}, a power of the fuel cell 41 is taken from the converter 15 and supplied to the network 20 when the network isolating switch 14 is closed. If a second return current circuit or means 18.2 is provided, a current flow or a power flow from the electrolyzer 31 can be suppressed.

A support of the network 20 may be necessary in that the power balance of the network between power generation and power consumption has an increased energy consumption and a frequency of the AC voltage in the AC network 20 in FIG. 1 is smaller than the nominal frequency associated with the AC network 20. This can be counteracted if the removal of the active power from the network 20 is reduced for operating the electrolyzer 31. For this purpose, the power consumption of the electrolyzer 31 can be controlled via a reduction of the output voltage U_{DC} applied to the converter. However, this is only possible up to the open-circuit voltage U_{0,EL} of the electrolyzer 31. The network can be supported more effectively by feeding in active power. For this purpose, the electrolysis plant 100 can switch into a fuel cell mode by controlling the output voltage U_{DC} applied to the common bidirectional converter 15 up to a value just below the open-circuit voltage U_{0,FC} of the fuel cell 41. In an opposed and corresponding manner, the electrolysis system 100 can also be controlled for network support if too much energy is generated in the power balance of the network 20. A need for supporting the network 20 can be triggered by a network parameter falling below a specified threshold value. This can be, for example, the frequency of the AC voltage in the AC network 25 or a magnitude of a DC voltage in a DC network 26 (see FIG. 3). This requirement can be determined via the measuring circuit with the voltage sensor 13, optionally also with the additional use of a frequency/power characteristic curve stored in the control circuit 19, and a suitable regulation and control of the individual components of the electrolysis system 100 can be carried out by means of the control circuit 19.

The common bidirectional converter 15 can be of one-stage or multi-stage design. A multi-stage, for example, a two-stage converter 15 in addition to a bidirectional DC/AC converter also comprises a DC/DC converter, e.g. a bidirectional DC/DC converter, which is connected downstream of the DC/AC converter in the direction of the device-side apparatus connections 12a and 12b. In this case, the bidirectional DC/DC converter is connected to the bidirectional DC/AC converter with one of its connections and forms, with its other connection, the device-side converter connection 15.2. For the different possible embodiments of the bidirectional converter 15 and also of the reverse current protection circuits or means 18.1, 18.2, please refer to FIG. 3a-3c.

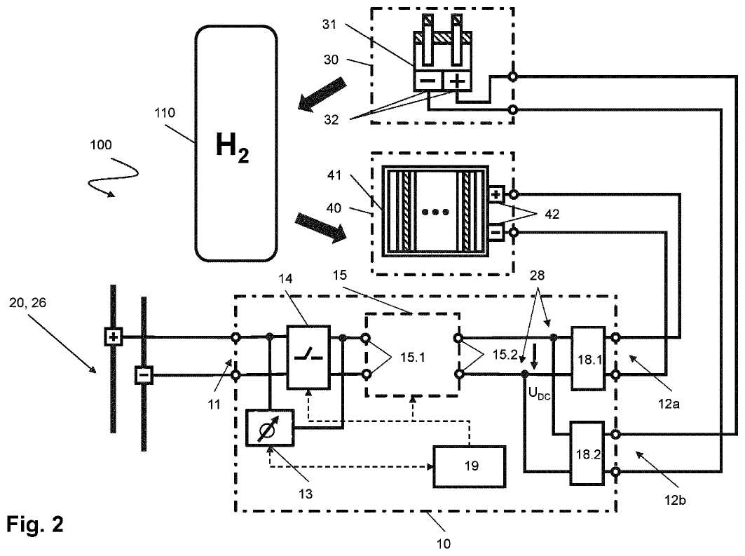

The embodiment of the electrolysis system 100 according to the disclosure shown in FIG. 2 largely corresponds to the embodiment of FIG. 1 in its components. In this embodiment, however, the network 20 is designed as a DC voltage (DC) network 26. Accordingly, the network-side apparatus connection 11 is configured to connect to the DC voltage network 26. The DC voltage network 26 may be, for example, an energy distribution network of an industrial operation, or a higher-level power distribution network to which different loads or buildings are connected with their corresponding power distribution networks. The common bidirectional converter 15 is configured as a DC/DC converter here and can be configured in a one-stage or a multi-stage manner, for example, comprising a plurality of DC/DC converters.

In FIGS. 3a, 3b and 3c, various embodiments of the common bidirectional converter 15 in the apparatus 10 according to the disclosure are shown, as can be provided in one of the embodiments of the electrolysis system 100 described above. The embodiment shown in FIG. 3a is set up for use in an electrolysis system 100 which is connected to an AC voltage network 25. The bidirectional converter 15 is in this case three-phase and is configured to link to a three-phase AC network 25. The bidirectional converter 15 is also configured in two stages and comprises a bidirectional DC/AC converter 16 and a bidirectional DC/DC converter 17a. The DC/DC converter 17a is connected downstream of the DC/AC converter 16 in the direction of the device-side converter connection 15.2. The bidirectional DC/DC converter 17a is connected to the DC side of the bidirectional DC/AC converter 16 with its one connection, and is connected to the device-side converter connection 15.2 with its other connection. Via the device-side converter connection 15.2, the converter 15 is connected, on the one hand, via a first reverse current protection circuit or means 18.1, shown by way of example in FIG. 3a as a diode D1, to the first device-side apparatus connection 12a of the apparatus 10 and further to the fuel cell 41. In addition, the device-side converter connection 15.2 is connected to the second device-side apparatus connection 12b of the apparatus 10 and further to the electrolyzer 31 via the second reverse current protection circuit or means 18.2, in FIG. 3a likewise shown as a diode D2 by way of example. The bidirectional DC/AC and DC/DC converters 16, 17a are controlled by a control circuit 19. By adjusting the DC voltage which is present before or after the DC/DC converter 17a up or down, the operating requirements of the terminal devices, electrolyzer and fuel cell can be suitably decoupled. The two-stage design of the bidirectional converter 15 allows for a greater degree of freedom in the selection of the operating voltages of the terminal devices relative to the boundary conditions of the AC network. Specifically, for example, the DC/DC converter 17a can perform a conversion of a DC voltage in a boosting manner in the direction of the AC network in the feed mode in order to also enable an operating voltage of the fuel cell below the minimum required DC input voltage of the DC/AC converter 16. Alternatively, when power is drawn from the AC network 25, the DC/DC converter 17a can perform a bucking conversion in the direction of the device-side converter connection 15.2 in order to allow for an operating voltage of the electrolyzer below a minimum possible rectified converter voltage of the DC/AC converter 16. The reverse current protection circuit or means 18.1, 18.2 of the fuel cell branch and the electrolyzer branch are here configured as diodes D1 and D2. Via the DC voltage U_{DC} applied to the device-side converter connection 15.2, the fuel cell 41 and the electrolyzer 31 can be controlled. The suitable choice of the voltage U_{DC} greater than the open-circuit voltage U_{0,EL} of the electrolyzer 31 thereby allows an operating mode of the electrolysis system 100 in electrolysis operation with power consumption from the AC network 25. In contrast, a voltage U_{DC} smaller than the open-circuit voltage U_{0,FC} allows the fuel cell 41 to have an operating mode of the electrolysis system 100 in fuel cell operation, i.e. with power feed into the connected AC network 25.

However, in one embodiment the common bidirectional converter 15 can also be configured in one stage, as shown in FIG. 3b. Here, only one single-stage DC/AC converter 16 is provided without a second DC/DC converter stage 17a being provided. If the bidirectional DC/AC converter 16 is configured in a two-level topology, the DC voltage U_{DC} applied to the device-side converter connection 15.2 can be greater or equal to the amplitude of the AC voltage Û₁₁ prevailing at the network-side converter connection 15.1 or at the network-side apparatus connection 11. If the bidirectional DC/AC converter 16 is configured in a three-level topology, the DC voltage U_{DC} applied to the device-side converter connection 15.2 can be greater than or equal to twice the amplitude of the AC voltage Û₁₁ prevailing at the network-side converter connection 15.1 or at the network-side apparatus connection 11. Although the reverse current protection circuit or means 18.1, 18.2 in FIG. 3b are each shown as a diode, an embodiment of the reverse current protection circuit or means 18.1, 18.2 is alternatively also possible as switches S1, S2 or switches and diode S1, D2 or S2, D1.

In a further embodiment shown in FIG. 3c, the apparatus 10 is configured to connect to a network designed as a DC network 26. Accordingly, the converter 15 here comprises a bidirectional DC/DC converter 17b. The DC/DC converter 17b is then able to influence the DC network voltage applied to its network-side converter connection 15.1 by power feed or power consumption as a step-up converter or buck converter. In this embodiment, the two reverse-current protection circuits or means 18.1, 18.2 are configured as switches S1 and S2 by way of example. These can be electro-mechanical switches or actively controlled semiconductor switches. In all embodiments 3a, 3b, and 3c, it is possible In each case to carry out both reverse current protection means as diodes D1 and D2, as switches S1 and S2, or as a combination of diode D1 and switch S2 or switch S1 and diode D2. It is also within the scope of the disclosure to provide no second reverse current protection circuits or means 18.2, or D2, S2, which is connected to the electrolyzer 31. Furthermore, it is possible for the first or second reverse current protection circuits or means to be configured in each case as a parallel circuit of an actively controlled semiconductor switch and an electromechanical switch, or as a parallel circuit of a diode and an electromechanical switch. In one embodiment of the first reverse current protection circuit or means as a parallel circuit of a diode D1 and an electromechanical switch S1, the electromechanical switch S1 can, with a DC voltage U_{DC} applied to the device-side converter connection 15.2 be closed if the DC voltage falls below a threshold below the open-circuit voltage U_{0,FC} of the fuel cell 41, whereby the power loss converted in the diode D1 is reduced. In the case of a temporal increase, the DC voltage U_{DC} applied to the converter connection 15.2, the electromechanical switch S1 is opened when the DC voltage U_{DC} reaches or exceeds the threshold value. The threshold value is, in one embodiment, between 0.7 V and 5 V below the open-circuit voltage U_{0,FC} of the fuel cell 41. The situation is analogous in a second reverse current protection circuit or means 18.2 in the path of the electrolyzer 31, which is formed by a parallel circuit of a diode D2 and an electromechanical switch S2. In this case, the electromechanical switch S2 is closed when the DC voltage U_{DC} applied to the device-side converter connection 15.2 increases and when the DC voltage U_{DC} is within the voltage band associated with the electrolyzer operating mode. This applies, for example, when a further threshold value of the DC voltage U_{DC} is exceeded above the open-circuit voltage U_{0,EL} of the electrolyzer 31, wherein the further threshold value is, in one embodiment, between 0.7 V and 5 V above the open-circuit voltage U_{0,EL} of the electrolyzer 31.

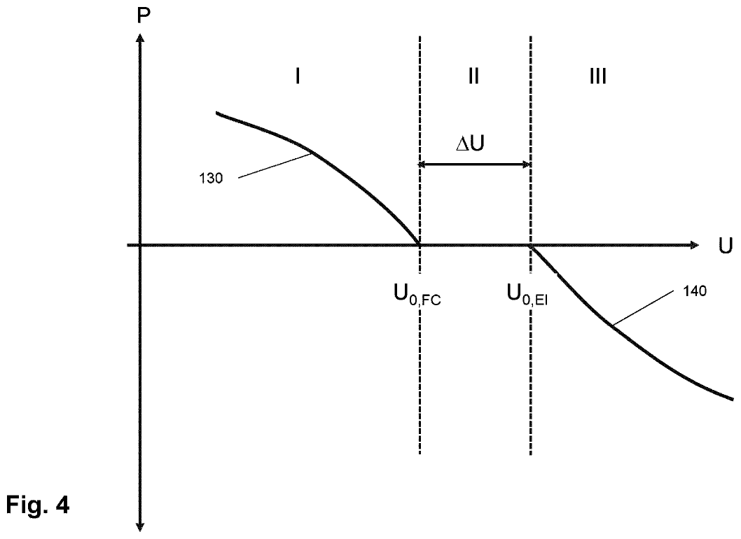

FIG. 4 illustrates schematically a characteristic curve 130 of the fuel cell 41 and a characteristic curve 140 of the electrolyzer 31 (in each case in the form of a power-voltage characteristic) according to one embodiment of the method according to the disclosure. It should be noted that the symbol P in the graph stands for a power that is supplied to (i.e., fed into) the network, wherein a positive value for P (P>0) means that electric power is fed into the network 20, and a negative value of P (P<0) means that electric power is drawn from the network and consumed in the electrolyzer (or in other words a negative electric power P is fed into the network).

The region I is associated with a voltage band of the operating mode of the fuel cell 41. In this region I, the fuel cell 41 provides the electrical active power P, for example, by the reaction of hydrogen and oxygen to form water. The power output 130 decreases with increasing DC voltage U_{DC} until the DC voltage U_{DC} reaches a value that corresponds to an open-circuit voltage U_{0,FC} of the fuel cell 41. The open-circuit voltage U_{0,FC} corresponds to a terminal voltage in the currentless state of the fuel cell 41. The region III designates a voltage band of the operating mode of the electrolyzer 31. In this region III, the electrolyzer 31 draws electrical active power P from the network, for example, by separating water into its components hydrogen and oxygen. Power consumption 140 of the electrolyzer begins at a value U_{0,EL} which corresponds to an open-circuit voltage U_{0,EL} of the electrolyzer 31 and increases further (corresponding to a decreasing power fed into the network) with increasing DC voltage U_{DC}. Since the open-circuit voltages are now selected such that the open-circuit voltage U_{0,FC} of the fuel cell 41 is less than the open-circuit voltage U_{0,EL} of the electrolyzer 31, there is a resulting selective operation of the electrolyzer 31 in an upper voltage band of the DC voltage U_{DC}, region III and a selective operation of the fuel cell 41 in a lower voltage band of the DC voltage U_{DC}, region I. The same also applies if the open-circuit voltage U_{0,FC} of the fuel cell 41 is equal to the open-circuit voltage U_{0,EL} of the electrolyzer 31, and hence both voltage bands are thus directly adjacent to one another. It is thus advantageous that the voltage bands do not overlap, but have at most the same starting and end points in order to prevent a power flow into the fuel cell. Advantageously, in one embodiment, a region II is formed which characterizes a voltage band ΔU≠0, wherein ΔU is a voltage difference between the open-circuit voltage U_{0,FC} of the fuel cell 41 and the open-circuit voltage U_{0,EL} of the electrolyzer.

In the case of directly adjacent voltage bands of the electrolyzer 31 and the fuel cell 41, individual electrolysis cells can easily be above their associated open-circuit voltage U_{0,EL} in spite of a DC voltage U_{DC} applied to the connections of the electrolyzer 31 at the level of its nominally specified open-circuit voltage U_{0,EL}. An electrolysis reaction can thus already take place In these electrolysis cells, although this is not intended yet. In the embodiment of the method shown, electrolyzer 31 and fuel cell 41 are matched to one another in their design such that, in one embodiment, the open-circuit voltage of the electrolyzer U_{0,EL} is at least 0.1 V, for example, at least 1 V and further, for example, by at least 10 V above the open-circuit voltage of the fuel cell U_{0,FC}. In this case, the voltage bands of the electrolyzer 31 (region III) and fuel cell 41 (region I) are spaced apart from one another via a voltage range (region II) different from 0 V. Via the distance of both open-circuit voltages from one another, an electrolysis reaction which is unintentionally running in individual electrolysis cells can be suppressed, or at least reduced.

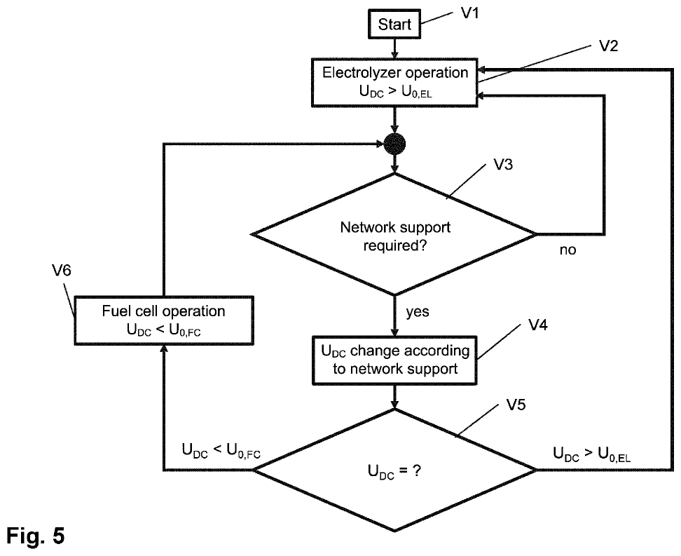

FIG. 5 schematically shows a flow diagram for a method for operating an electrolysis system 100 according to the disclosure, which can be used for network support.

The method starts in a method step or act V1, in which a startup of the electrolysis system 100 is carried out. In a second method step or act V2, the electrolysis system 100 initially operates in the electrolyzer operating mode. This is active when the DC voltage U_{DC} at the device-side converter connection 15.2 of the apparatus 10 is greater than the open-circuit voltage U_{0,EL} of the electrolyzer 31, i.e when U_{DC}>U_{0,EL} applies. The electrolyzer operating mode is essentially also the standard operating mode of the electrolysis system 100, which has the actual intrinsic benefit of producing an electrolysis product—e. g H₂—to be utilized for its intended purpose—for example, steel production. In the event that the fuel cell 41 is likewise operated with one of the electrolysis products as combustion gas, the storage tank 110 can additionally be filled up. In the electrolyzer operating mode, an active power is taken from the connected network 20, wherein the network 20 can be configured as an AC network 25 or as a DC network 26. In addition to the electrolysis operating mode, the electrolysis system 100 can also be operated in a fuel cell operating mode which is active when the DC voltage U_{DC} at the device-side converter connection 15.2 of the apparatus 10 is less than the open-circuit voltage U_{0,FC} of the fuel cell 41, U_{DC}<U_{0,FC} (method step or act V6). In a third method step or act V3 following the second method step or act V2, it is checked whether network support is required or requested. Network support can firstly be triggered by a network operator prompting or requesting network support by increasing active power feed in or reducing active power consumption from the network 20, for example, via radio or cable. However, the network support can also be triggered by the monitoring of the network parameters carried out by the apparatus 10 with its measuring circuit 13 when determining a deviation from the target parameter values associated with the network. In one embodiment, the frequency (in the case of AC networks) and the level of the network voltage (in DC networks and AC networks) are relevant as network parameters here. If no network support is required, the method jumps back to method step or act V2 and the electrolysis system 100 remains in its current electrolysis mode, without carrying out a network-regulating task. If, on the other hand, it is determined that a network support is required, in a fourth method step or act V4, the control circuit 19 determines which type of network support is necessary or sufficient, and the DC voltage U_{DC} applied to the device-side converter connection 15.2 is changed correspondingly. As long as the level of the DC voltage U_{DC} applied to the device-side converter connection 15.2 is now in the fifth method step or act V5 even after the change thereof in the fourth method step or act V4, even above the open-circuit voltage U_{0,EL} of the electrolyzer 31, i.e. when U_{DC}>U_{0,EL} applies, the method jumps to the second method step or act V2—the electrolyzer operating mode—in which the electrolyzer 31 is operated again selectively—but now with a modified power flow. If, on the other hand, the fifth method step or act V5 results in that after the change in the DC voltage U_{DC} in the fourth method step or act V4, the height thereof is now smaller than the open-circuit voltage U_{0,FC} of the fuel cell 41, i.e, U_{DC}<U_{0,FC} applies, the method branches from the fifth method step V5 into a sixth method step or act V6 in which the fuel cell 41 is operated selectively, while an electrolysis reaction in the electrolyzer 31 is suppressed. The method then jumps to the third method step or act V3, in which it is checked again whether network support is required.

In the fourth method step or act V4, on the one hand, it can be determined that an increase in the power consumption from the network 20 is required, for example, if the power balance of the network 20 has an increased energy generation compared to the energy consumption. The control circuit 19 can then increase the power consumption of the electrolyzer 31 by increasing the DC voltage U_{DC} if the electrolysis system 100 is currently in the electrolyzer operating mode, or change into the electrolyzer operating mode when it is currently in the fuel cell operating mode. To do this, the DC voltage U_{DC} from region I over the value of the open-circuit voltage of the fuel cell U_{0,FC} is further increased in order to initially terminate the fuel cell operation and further switch over the value of the open-circuit voltage of the electrolyzer U_{0,EL} in order to switch into the electrolysis operation (region III). As a result, the electrolysis system 100 changes from operation with active power feed (method step or act V6) into the network 20 into operation with active power consumption from the network 20. (Method step or act V2).

On the other hand, it can also be determined in the fourth method step or act V4 that a power supply, or an increase in power feed into the network 20, is required, for example, if the power balance of the network has an increased energy consumption compared to energy generation. The control circuit 19 can then increase the power output of the fuel cell 41 by adjusting the DC voltage U_{DC} when the electrolysis system 100 is currently in the fuel cell operating mode, or changes in the fuel cell operating mode when it is currently in the electrolyzer operating mode. To do this, the DC voltage U_{DC} from region III must be decreased below the value of the open-circuit voltage of the electrolyzer U_{0,EL} in order to initially terminate the electrolysis operation and further below the value of the open-circuit voltage of the fuel cell U_{0,FC} in order to change in fuel cell operation (region I). As a result, the electrolysis system changes from operation with active power consumption from the network 20 (method step or act V2) into operation with active power feed into the network 20. (Method step or act V6).

What is claimed is:

1. A method for operating an electrolyzer and a fuel cell which are connected in parallel with one another with a device-side converter connection of a common bidirectional converter, and wherein a network-side converter connection of the common bidirectional converter is coupled to a network,
wherein the electrolyzer comprises an open-circuit electrolyzer voltage characterizing an electrolysis reaction that begins in the electrolyzer, and the fuel cell comprises an open-circuit fuel cell voltage characterizing a terminal voltage in a currentless state of the fuel cell, and
wherein the electrolyzer and the fuel cell are configured such that the open-circuit electrolyzer voltage of the electrolyzer is greater than or equal to the open-circuit fuel cell voltage of the fuel cell, comprising:
operating the common bidirectional converter with a DC voltage applied to its device-side converter connection higher than the open-circuit electrolyzer voltage of the electrolyzer to control an electrolysis reaction running in the electrolyzer, wherein a power is taken from the network and supplied to the electrolyzer by the converter, and a current into the fuel cell is suppressed by a first reverse current protection circuit, and
operating the common bidirectional converter with a DC voltage applied to its device-side converter connection lower than the open-circuit fuel cell voltage of the fuel cell U_{0,FC} wherein a power is taken from the fuel cell and supplied to the network by means of the common bidirectional converter.

2. The method according to claim 1, wherein during the operation of the common bidirectional converter with a DC voltage U_{DC} applied to its device-side converter connection that is lower than the open-circuit fuel cell voltage of the fuel cell, a current from the electrolyzer in the direction of the common bidirectional converter is suppressed via a second reverse current protection circuit.

3. The method according to claim 1, wherein the network is an alternating voltage (AC) network, and wherein the common bidirectional converter comprises a bidirectional DC/AC converter.

4. The method according to claim 3, wherein the common bidirectional converter is configured as a multi-stage converter comprising the bidirectional DC/AC converter and a bidirectional DC/DC converter.

5. The method according to claim 1, wherein the network is configured as a DC network, and wherein the common bidirectional converter comprises a bidirectional DC/DC converter.

6. The method according to claim 1, wherein the open-circuit electrolyzer voltage of the electrolyzer is at least 0.1 V higher than the open-circuit fuel cell voltage of the fuel cell.

7. The method according to claim 1, wherein the fuel cell is supplied with a fuel gas generated by the electrolyzer.

8. The method according to claim 1, wherein the network is configured as an AC network and the DC voltage applied to the device-side converter connection depends on a network parameter of the AC network.

9. The method according to claim 1, wherein the network is configured as a DC network and the DC voltage applied to the device-side converter connection depends on a network parameter of the DC network.

10. The method according to claim 3, wherein the common bidirectional converter is configured as a single-stage converter, and the DC voltage applied to the device-side converter connection is greater than or equal to the amplitude of the AC network.

11. An apparatus for operating an electrolyzer and a fuel cell comprising:
a network-side apparatus connection configured to connect to a network, a first device-side apparatus connection configured to connect to the fuel cell and a second device-side apparatus connection configured to connect to the electrolyzer,
a common bidirectional converter connected to the network-side apparatus connection via a network-side converter connection thereof, and connected via a device-side converter connection to the first device-side apparatus connection via a first reverse current protection circuit, and connected to the second device-side apparatus connection via the device-side converter connection,
a control circuit configured to control the common bidirectional converter,
wherein the apparatus, via the control circuit, is configured to:
operate the common bidirectional converter with a DC voltage applied to its device-side converter connection higher than an open-circuit electrolyzer voltage of the electrolyzer to control an electrolysis reaction running in the electrolyzer, wherein a power is taken from the network and supplied to the electrolyzer by the converter, and a current into the fuel cell is suppressed by the first reverse current protection circuit, and
operate the common bidirectional converter with a DC voltage applied to its device-side converter connection lower than the open-circuit fuel cell voltage of the fuel cell U_{0,FC} wherein a power is taken from the fuel cell and supplied to the network by means of the common bidirectional converter.

12. The apparatus according to claim 11, wherein the bidirectional converter comprises a single-stage converter.

13. The apparatus according to claim 11, wherein the bidirectional converter comprises a multi-stage converter comprising an AC/DC converter and a downstream DC/DC converter.

14. The apparatus according to claim 11, wherein the first reverse current protection circuit comprises a diode or a switch.

15. The apparatus according to claim 11, further comprising a second reverse current protection circuit arranged between the second device-side apparatus connection and an electrical link between the device-side converter connection and the first reverse current protection circuit.

16. The apparatus according to claim 15, wherein the second reverse current protection circuit comprises a diode or a switch.

17. An electrolysis system for operation on a network, comprising an electrolysis unit comprising an electrolyzer, a fuel cell unit comprising a fuel cell, and an apparatus comprising:
a network-side apparatus connection configured to connect to a network, a first device-side apparatus connection configured to connect to the fuel cell and a second device-side apparatus connection configured to connect to the electrolyzer,
a common bidirectional converter connected to the network-side apparatus connection via a network-side converter connection thereof, and connected via a device-side converter connection to the first device-side apparatus connection via a first reverse current protection circuit, and connected to the second device-side apparatus connection via the device-side converter connection,
a control circuit configured to control the common bidirectional converter,
wherein the apparatus, via the control circuit, is configured to:
operate the common bidirectional converter with a DC voltage applied to its device-side converter connection higher than an open-circuit electrolyzer voltage of the electrolyzer to control an electrolysis reaction running in the electrolyzer, wherein a power is taken from the network and supplied to the electrolyzer by the converter, and a current into the fuel cell is suppressed by a first reverse current protection circuit, and
operate the common bidirectional converter with a DC voltage applied to its device-side converter connection lower than the open-circuit fuel cell voltage of the fuel cell U_{0,FC} wherein a power is taken from the fuel cell and supplied to the network by means of the common bidirectional converter.

18. The electrolysis system according to claim 17, further comprising a storage tank configured to store an electrolysis product produced by the electrolyzer, wherein the storage tank is connected to the fuel cell for supplying a fuel gas.
